(19) United States
(12) Patent Application Publication
(10) Pub. No.: US 2026/0159132 A1
(43) Pub. Date: Jun. 11, 2026

(54) VEHICLE CONTROL DEVICE AND METHOD

(71) Applicants: Hyundai Motor Company, Seoul (KR); Kia Corporation, Seoul (KR)

(72) Inventor: Seung Jai AHN, Hwaseong-Si (KR)

(21) Appl. No.: 19/334,004

(22) Filed: Sep. 19, 2025

(30) Foreign Application Priority Data
Dec. 10, 2024 (KR) 10-2024-0182448

(51) Int. Cl. B60W 60/00; B60W 30/182; G06V 20/56

(52) U.S. Cl. CPC B60W 60/00184; B60W 30/182; B60W 60/0059; G06V 20/588; B60W 2420/403; B60W 2552/53; B60W 2556/20; B60W 2556/40; B60W 2556/65

(57) ABSTRACT

A vehicle control device is provided. The vehicle control device may determine, based on object recognition information received from a sensor of a vehicle, first traffic lane marking information; and determine, based on map information received from a navigation system of the vehicle, second traffic lane marking information; and generate combined traffic lane marking information of the vehicle by comparing the first traffic lane marking information with the second traffic lane marking information. The combined traffic lane marking information may indicate at least one unmatched traffic lane marking for which the first traffic lane marking information and the second traffic lane marking information do not match. The vehicle control device may further control, based on the combined traffic lane marking information, a driving operation of the vehicle.

### CROSS-REFERENCE TO RELATED APPLICATION

This application claims priority to and the benefit of Korean Patent Application No. 10-2024-0182448, filed on Dec. 10, 2024, the disclosure of which is incorporated herein by reference in its entirety.

### FIELD

The present disclosure relates to a vehicle control device and method.

### BACKGROUND

Autonomous vehicle systems may use multiple sensors and high-definition (HD) maps to accurately recognize roads and driving environments. A vehicle may compare traffic line (e.g., pavement marking) information detected by various sensors such as a camera, a lidar, and a radar with lane line information stored on an HD map in real time. This process allows a location of the vehicle to be accurately identified, a driving route to be determined, and safe driving to be ensured.

However, when there is a mismatch between sensor data and HD map information, a current autonomous driving system employs a method of immediately disabling or stopping an autonomous driving mode to ensure driving safety. This simple response may seem reasonable at first glance in terms of increasing the stability of the autonomous driving system, but the response may cause problems such as disruption of traffic flow and a decrease in the marketability of autonomous vehicles.

### SUMMARY

The present disclosure is directed to providing a vehicle control device and method capable of maintaining stable driving even in a situation where lane line information recognized by an autonomous vehicle and lane line information of an HD map do not match.

The present disclosure is also directed to providing a vehicle control device and method capable of diagnosing a cause of a problem and generating an alternative route if lane line information does not match.

According to one or more example embodiments of the present disclosure, a vehicle control device may include a plurality of processors and a memory storing at least one instruction. The plurality of processors may include a first processor, a second processor, and a third processor. The at least one instruction may be configured, when executed by the first processor communicating with the memory, to cause the vehicle control device to: determine, based on object recognition information received from a sensor of a vehicle, first traffic lane marking information; and determine, based on map information received from a navigation system of the vehicle, second traffic lane marking information. The at least one instruction may be configured, when executed by the second processor communicating with the memory, to further cause the vehicle control device to generate combined traffic lane marking information of the vehicle by comparing the first traffic lane marking information with the second traffic lane marking information. The combined traffic lane marking information may indicate at least one unmatched traffic lane marking for which the first traffic lane marking information and the second traffic lane marking information do not match. The at least one instruction may be configured, when executed by the third processor communicating with the memory, to further cause the vehicle control device to control, based on the combined traffic lane marking information, a driving operation of the vehicle.

The at least one instruction may be configured, when executed by the second processor communicating with the memory, to further cause the vehicle control device to: determine the at least one unmatched traffic lane marking by comparing at least one of coordinates, traffic lane marking slopes, or angles of the first traffic lane marking information and the second traffic lane marking information.

The at least one instruction may be configured, when executed by the third processor communicating with the memory, to cause the vehicle control device to control the driving operation of the vehicle by: controlling, based on a determination that a destination of the vehicle is unreachable by driving on a traffic lane associated with the unmatched traffic lane marking, the vehicle to avoid driving on the traffic lane associated with the unmatched traffic lane marking.

The at least one instruction may be configured, when executed by the third processor communicating with the memory, to cause the vehicle control device to control the driving operation of the vehicle by: causing, based on a determination that the destination of the vehicle is unreachable by avoiding driving on the traffic lane associated with the unmatched traffic lane marking, deactivation of an autonomous driving operation of the vehicle or an autonomous driving level change of the autonomous driving operation of the vehicle.

The at least one instruction may be configured, when executed by the third processor communicating with the memory, to cause the vehicle control device to control the driving operation of the vehicle by: comparing the combined traffic lane marking information generated by the vehicle control device with second combined traffic lane marking information generated by a second vehicle.

The at least one instruction may be configured, when executed by the third processor communicating with the memory, to cause the vehicle control device to control the driving operation of the vehicle by: determining, based on the unmatched traffic lane marking not being identified in the second combined traffic lane marking information as being unmatched, the combined traffic lane marking information generated by the vehicle to be inaccurate.

The at least one instruction may be configured, when executed by the third processor communicating with the memory, to cause the vehicle control device to control the driving operation of the vehicle by: causing, based on the determination that the combined traffic lane marking information generated by the vehicle being inaccurate, deactivation of an autonomous driving operation of the vehicle or an autonomous driving level change of the autonomous driving operation of the vehicle.

The at least one instruction may be configured, when executed by the third processor communicating with the memory, to cause the vehicle control device to control the driving operation of the vehicle by: based on the unmatched traffic lane marking being identified in the second combined traffic lane marking information as being unmatched, transmitting, to a server, the combined traffic lane marking information generated by the vehicle and the second combined traffic lane marking information generated by the second vehicle.

The at least one instruction may be configured, when executed by the third processor communicating with the memory, to cause the vehicle control device to control the driving operation of the vehicle by: controlling, based on a determination that a destination of the vehicle is unreachable by driving on a traffic lane associated with the unmatched traffic lane marking, the vehicle to avoid driving on the traffic lane associated with the unmatched traffic lane marking.

The at least one instruction may be configured, when executed by the third processor communicating with the memory, to cause the vehicle control device to control the driving operation of the vehicle by: causing, based on a determination that the destination of the vehicle is unreachable by avoiding driving on the traffic lane associated with the unmatched traffic lane marking, deactivation of an autonomous driving operation of the vehicle or an autonomous driving level change of the autonomous driving operation of the vehicle.

According to one or more example embodiments of the present disclosure, a method performed by an apparatus of a vehicle may include: determining, based on object recognition information received from a sensor of the vehicle, first traffic lane marking information; and determining, based on map information received from a navigation system of the vehicle, second traffic lane marking information; generating combined traffic lane marking information of the vehicle by comparing the first traffic lane marking information with the second traffic lane marking information. The combined traffic lane marking information may indicate at least one unmatched traffic lane marking for which the first traffic lane marking information and the second traffic lane marking information do not match. The method may further include controlling, based on the combined traffic lane marking information, a driving operation of the vehicle.

The method may further include: determining the at least one unmatched traffic lane marking by comparing at least one of coordinates, traffic lane marking slopes, or angles of the first traffic lane marking information and the second traffic lane marking information.

Controlling the driving operation of the vehicle may include: controlling, based on a determination that a destination of the vehicle is unreachable by driving on a traffic lane associated with the unmatched traffic lane marking, the vehicle to avoid driving on the traffic lane associated with the unmatched traffic lane marking.

Controlling the driving operation of the vehicle may include: causing, based on a determination that the destination of the vehicle is unreachable by avoiding driving on the traffic lane associated with the unmatched traffic lane marking, deactivation of an autonomous driving operation of the vehicle or an autonomous driving level change of the autonomous driving operation of the vehicle.

Controlling the driving operation of the vehicle may include: comparing the combined traffic lane marking information generated by the apparatus of the vehicle with second combined traffic lane marking information generated by a second vehicle.

Controlling the driving operation of the vehicle may include: determining, based on the unmatched traffic lane marking not being identified in the second combined traffic lane marking information as being unmatched, the combined traffic lane marking information generated by the vehicle to be inaccurate.

Controlling the driving operation of the vehicle may include: causing, based on the determination that the combined traffic lane marking information generated by the vehicle being inaccurate, deactivation of an autonomous driving operation of the vehicle or an autonomous driving level change of the autonomous driving operation of the vehicle.

Controlling the driving operation of the vehicle may include: based on the unmatched traffic lane marking being identified in the second combined traffic lane marking information as being unmatched, transmitting, to a server, the combined traffic lane marking information generated by the vehicle and the second combined traffic lane marking information generated by the second vehicle.

Controlling the driving operation of the vehicle may include: controlling, based on a determination that a destination of the vehicle is unreachable by driving on a traffic lane associated with the unmatched traffic lane marking, the vehicle to avoid driving on the traffic lane associated with the unmatched traffic lane marking.

Controlling the driving operation of the vehicle may include: causing, based on a determination that the destination of the vehicle is unreachable by avoiding driving on the traffic lane associated with the unmatched traffic lane marking, deactivation of an autonomous driving operation of the vehicle or an autonomous driving level change of the autonomous driving operation of the vehicle.

### BRIEF DESCRIPTION OF THE DRAWINGS

The above and other objects, features and advantages of the present disclosure will become more apparent to those of ordinary skill in the art by describing one or more example embodiments thereof in detail with reference to the accompanying drawings, in which:

FIG. 1 is a view showing a vehicle transmitting and receiving data by communicating with other devices;

FIG. 2 is a diagram showing modules constituting a vehicle;

FIG. 3 is a diagram for describing the operation of a vehicle control device;

FIGS. 4, 5, and 6 are operation concept diagrams of a vehicle control device.

FIG. 7 is a flowchart of a method of controlling a vehicle.

### DETAILED DESCRIPTION

Hereinafter, one or more example embodiments of the present disclosure will be described in detail with reference to the accompanying drawings.

However, the technical idea of the present disclosure is not limited to the example embodiments to be described but may be implemented in various different forms, and within the scope of the technical idea of the present disclosure, one or more among components in the example embodiments may be used by being selectively combined and substituted.

Further, unless specifically defined and described, terms used in the example embodiments of the present disclosure (including technical and scientific terms) may be interpreted as meanings which are generally understood by those skilled in the art to which the present disclosure pertains, and commonly used terms such as terms defined in dictionaries may be interpreted in consideration of the contextual meaning of the related art.

The terms used in the one or more example embodiments of the present disclosure are for the purpose of describing the example embodiments only and are not intended to limit the disclosure.

In the present specification, the singular forms may include the plural forms unless the context clearly dictates otherwise. For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

Throughout the present disclosure, references to components, units, or modules generally refer to items that logically can be grouped together to perform a function or group of related functions. Like reference numerals are generally intended to refer to the same or similar components. Components, units, and modules may be implemented in software, hardware or a combination of software and hardware. The components, units, modules, and/or functions described above may be implemented and/or performed by one or more processors. For examples, the components, units, and/or modules may include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The components, units, and/or modules may also include software control module(s) implemented with a processor or logic circuitry for example. The components, units, and/or modules may include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware. One or more storage type media may include any or all of the tangible memory of computers, processors, or the like, or associated modules thereof, such as various semiconductor memories, tape drives, disk drives and the like, which may provide non-transitory storage at any time for software programming.

In addition, when describing components of example embodiments of the present disclosure, terms such as first, second, A, B, (a), (b), etc., may be used.

These terms are only for distinguishing the components from other components, and the essence, sequence, or order of the components is not limited by these terms.

In addition, when a component is described as being “linked,” “coupled,” or “connected” to another component, the component is not only directly linked, coupled, or connected to another component, but also “linked,” “coupled,” or “connected” to another component with still another component disposed between the component and the other component.

Further, when a component is described as being formed or disposed “on (above) or under (below)” another component, the term “on (above) or under (below)” includes not only when two components are in direct contact with each other, but also when one or more other components are formed or disposed between the two components. Further, when a component is described as being “on (above) or below (under),” the description may include the meanings of an upward direction and a downward direction based on one component.

Hereinafter, one or more example embodiments will be described in detail with reference to the accompanying drawings, but the same or corresponding components are denoted by the same reference numerals regardless of the drawing numbers, and redundant descriptions thereof will be omitted.

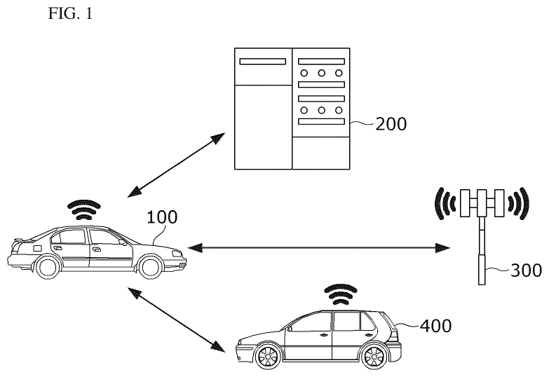

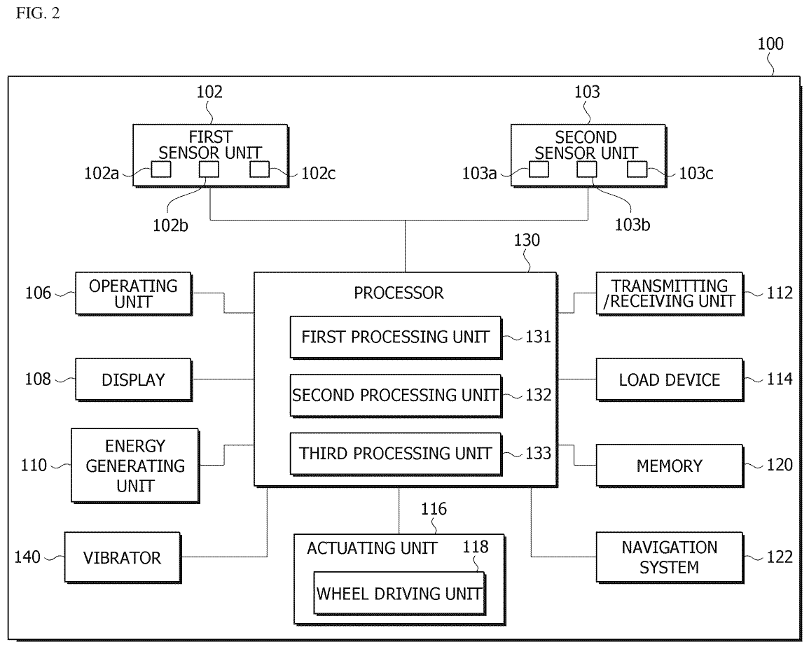

Hereinafter, a vehicle will be described with reference to FIGS. 1 and 2. FIG. 1 is a view illustrating a vehicle transmitting and receiving data by communicating with other devices;

Referring to FIG. 1, a vehicle 100 may be driven based on electrical energy or fossil energy. In the case of electrical energy, the vehicle 100 may be, for example, a battery-based vehicle driven only by a high-voltage battery, or may employ a gas-based fuel cell as an energy source. In addition, the fuel cell may use various types of gas capable of generating electrical energy, and the vehicle 100 may be filled with, for example, gas in a liquefied state. One example of the gas may be hydrogen. However, the gas is not limited thereto, and various gases are applicable. In the case of fossil energy, the vehicle 100 may be driven based on fuel such as gasoline, diesel, or liquefied gas, and may be equipped with an internal combustion engine that drives an actuating unit (also referred to as an actuator) 116 by combustion of the fuel. The engine may be included in an energy generating unit (also referred to as a generator, a power generator, an energy generator, etc.) 110 in terms of providing a driving rotational force of wheels to a wheel driving unit (e.g., a powertrain) 118. As another example, the vehicle 100 may drive the actuating unit 116 by selectively utilizing energy from a fossil energy-based internal combustion engine and an electric battery, and may be a hybrid type vehicle.

The vehicle 100 may refer to a movable device. The vehicle 100 may be a ground vehicle that travels on the ground and may be a typical passenger car, a commercial vehicle, a purpose-built vehicle (PBV), or the like. The vehicle 100 may be a four-wheeled vehicle, such as a passenger car, a sport utility vehicle (SUV), or a small truck, or may be a vehicle with more than four wheels, such as a bus, a large truck, a container transport vehicle, a heavy equipment vehicle, or the like. The ground vehicle may be referred to as any vehicle including a vehicle that moves underground as well as a vehicle that moves over land. The vehicle 100 may be a robot in a broad sense, such as a means of movement, and the robot may be moved using wheels, tracks, or other movement modules. In the present disclosure, ground mobility devices such as ground vehicles are mainly described, but unless it contradicts the present disclosure, the present disclosure may also be applied to air mobility devices such as advanced air mobility (AAM) vehicles, aircraft, or the like, and water mobility devices such as ships, submarines, or the like.

The vehicle 100 may be controlled and driven by autonomous driving, and the autonomous driving may be implemented as semi-autonomous driving or fully autonomous driving. Fully autonomous driving may be provided as autonomous movement in which a processor 130 of the vehicle 100 takes full control without user intervention, even if a driving situation is uncertain. Semi-autonomous driving may be provided as autonomous movement that requires driver intervention depending on specific driving situations. The semi-autonomous driving may be implemented so that the processor 130 transfers control to a user by deactivating autonomous driving when the aforementioned situation occurs, allowing the user to perform manual driving. According to the levels of autonomous driving defined by the Society of Automotive Engineers (SAE), the semi-autonomous driving may correspond to autonomous driving levels 1 to 4, and the fully autonomous driving may correspond to level 5.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

Based on one or more features (e.g., analyzing and comparing traffic marking information obtained from sensors and maps) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., analyzing and comparing traffic marking information obtained from sensors and maps) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., analyzing and comparing traffic marking information obtained from sensors and maps) described herein.

Minimum risk maneuver (MRM) operation(s) may also be controlled, for example, based on one or more features (e.g., analyzing and comparing traffic marking information obtained from sensors and maps) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., analyzing and comparing traffic marking information obtained from sensors and maps) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane.

The driving control apparatus may identify a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., analyzing and comparing traffic marking information obtained from sensors and maps) described herein.

An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, driver warning control, autonomous driving operational design domain (ODD), etc.).

An autonomous driving level and/or autonomous driving activation/deactivation may also be controlled, for example, based on one or more features (e.g., analyzing and comparing traffic marking information obtained from sensors and maps) described herein. A driving control apparatus may perform an autonomous driving level control (e.g., a change of an autonomous driving level, a change of a required user attentiveness, etc.) or cause deactivation of an autonomous driving operation. For example, by changing the required user attentiveness, the driver may be required to place his/her hands on the driving wheel more often (e.g., at least once in a threshold time period, such as five second, 30 seconds, 1 minute, etc.). By changing the required user attentiveness, the driver may be required to look ahead more often (e.g., at least once in a threshold time period, such as five second, 30 seconds, 1 minute, etc.). By changing the autonomous driving level, one or more video contents may not be displayed on a display of the vehicle.

The vehicle 100 may communicate with other devices 200 and 300 or another vehicle 400. Other devices may include, for example, a server 200 that supports various controls, state management, and driving of the vehicle 100, an intelligent transportation system (ITS) device 300 for receiving information from an ITS, various types of user devices, or the like. The server 200 may be, for example, an external device operated by a vehicle manufacturer or provided to service autonomous driving, and may receive connected data of the vehicle 100 or transmit data necessary for autonomous driving. The server 200 may transmit various information and software modules used to control the vehicle 100 to the vehicle 100 in response to requests and data transmitted from the vehicle 100 and the user device to support autonomous driving and various services of the vehicle 100.

The ITS device 300 may be, for example, a road side unit (RSU), and the ITS device 300 may assist the user in driving his or her own vehicle or support autonomous driving of the vehicle 100 by exchanging vehicle recognition data, driving operation control and state data, environmental data around the vehicle, map data, or the like, through vehicle-to-infrastructure (V2I) communication with the vehicle 100. The vehicle 100 may support manual driving or autonomous driving by exchanging the data listed above through vehicle-to-vehicle (V2V) communication with the other vehicle 400.

The vehicle 100 may communicate with other vehicles or other devices based on cellular communication, wireless access in vehicular environment (WAVE) communication, dedicated short range communication (DSRC), short-range communication, or other communication methods.

For example, the vehicle 100 may use a cellular communication network such as LTE or 5G, a Wi-Fi communication network, a WAVE communication network, or the like, for communication with the server 200, the ITS device 300, and the other vehicle 400. For another example, DSRC or the like used in the vehicle 100 may be used for communication between vehicles. The communication method between the vehicle 100, the server 200, the ITS device 300, the other vehicle 400, and the user device is not limited to the example embodiments described herein.

FIG. 2 is a diagram showing modules constituting a vehicle.

The vehicle 100 may include one or more sensors 102, an operating unit (also referred to as a user interface, a control panel, a dashboard, an instrument cluster, an instrument panel, etc.) 106, a display 108, a load device (also referred to as a load or an electrical load) 114, and a transmitting/receiving unit (also referred to a communication interface, a transceiver, etc.) 112.

The one or more sensors 102 may be provided with various types of detectors to detect various states and situations occurring in an external environment, an internal system, user operation, and a boarding space of the vehicle 100.

Specifically, the first sensor 102 may be provided with an externally oriented camera 102a, a lidar 102b, a radar 102c, and the like, to recognize dynamic and static objects present outside the vehicle 100. The camera 102a may recognize an external object as an image while the vehicle 100 is in use, generate image data, and transmit the image data to the processor 130. The lidar 102b may generate point cloud data as recognized data of the external object and transmit the point cloud data to the processor 130 to generate 3D spatial information that identifies at least a shape of the external object. In order to ascertain the presence of an external object and its relative distance, speed, direction, or the like, the radar 102c may emit radio waves of a specific frequency around the vehicle 100 and generate radar data through radio waves reflected from the external object. In the present disclosure, the sensor unit is illustrated as having the lidar 102b, but in other examples, the lidar 102b may not be mounted.

The first sensor 102 may generate object recognition information based on sensing data. The object recognition information may include information on the presence of an object, position information about the object, information on a distance between the vehicle 100 and the object, and information on a relative speed between the vehicle 100 and the object. External objects may be various objects related to the operation of the vehicle 100.

A second sensor unit 103 may be provided with a positioning sensor 103a, a wheel sensor 103b, an attitude sensor 103c, and the like, to confirm its own location, speed, driving attitude, and the like. The attitude sensor 103c may include a gyro sensor, an angular velocity sensor, an acceleration sensor, or the like. The attitude sensor may be an inertial measurement unit (IMU) sensor and may be equipped with a 3-axis accelerometer and a 3-axis gyroscope. The attitude sensor 103c may measure acceleration in a traveling direction (x), acceleration in a lateral direction (y), and acceleration in a height direction (z) of the vehicle 100, and a yaw, a pitch, and a roll as the angular velocity of the vehicle.

The second sensor unit 103 may generate vehicle driving information based on sensing data. The vehicle driving information may be information generated based on data detected by various sensors installed inside the vehicle. For example, the vehicle driving information may include vehicle attitude information, vehicle speed information, vehicle inclination information, vehicle weight information, vehicle direction information, vehicle battery information, vehicle fuel information, vehicle tire pressure information, vehicle steering information, vehicle interior temperature information, vehicle interior humidity information, pedal position information, vehicle engine temperature information, and the like.

In addition, the vehicle driving information may include route information. The route information may refer to information generated based on a destination input by a vehicle user through the operating unit 106. The route information may refer to information that indicates a traveling route from a current position of a host vehicle to a destination on a map if the destination has been set. If no destination is set, the route information may refer to information including a road on which the host vehicle is currently traveling and a future driving route including the road.

A third sensor unit 105 may include a voice sensor 105a that collects voice signals inside the vehicle, a vibration sensor 105b disposed around the occupant, and a camera 105c that captures the inside of the vehicle.

The voice sensor 105a may include at least one microphone disposed inside the vehicle, and may collect voices and humming sounds expressed by the occupant inside the vehicle to generate a voice signal (e.g., an electrical signal).

The vibration sensor 105b may include at least one acceleration sensor or gyro sensor disposed at a position where the occupant's body may touch, and may generate a vibration signal (e.g., an electrical signal) by measuring the vibrations generated if a steering wheel, a console box, or a dashboard inside the vehicle is touched or tapped.

The camera 105c may capture the inside of the vehicle, and may be disposed to face the front of the upper body of the occupant, thereby generating a video signal by capturing the movements of the occupant.

The operating unit 106 may be configured as a module that is controlled by the user for driving. For example, the operating unit 106 may be a steering wheel for manual driving, an automatic or manual shift transmission, an accelerator pedal, a brake pedal, or the like. The operating unit 106 may be further provided with an interface for enabling or disabling an autonomous driving mode and selecting detailed functions requested by the user so that the user may use an autonomous driving function. In order to receive various requests related to autonomous driving, the operating unit 106 may be configured, for example, as a hard-type interface provided at a predetermined position inside the vehicle 100, or as a soft-type interface that can be touched on the display 108. Depending on the specifications of the autonomous vehicle, at least one of the steering wheel, the transmission, and the pedal may be omitted. For another example, the operating unit 106 may be provided with a module that receives a user's control request for the load device 114 in addition to driving control.

The display 108 may function as a user interface. The display 108 may output and display an operating state, a control state, route/traffic information, remaining energy amount information, content requested by the driver, or the like, of the vehicle 100 by the processor 130. In addition, the display 108 may be configured as a touch screen capable of detecting a driver's input to receive a driver's request to instruct the processor 130.

The load device 114 may be mounted on the vehicle 100 and may be any electrical device that is unrelated to a driving power system such as the wheel driving unit 118 or the like. The load device 114 may be an auxiliary device that receives electrical power from the energy generating unit 110, and may be, for example, an air conditioning system, a lighting system, a seat system, various devices installed in the vehicle 100, or the like. In the present disclosure, a cooling/heating system that cools or heats at least one of a battery, a fuel cell, an internal combustion engine, an air conditioning system, and a specific part of the vehicle 100 may be further included.

The transmitting/receiving unit 112 may support mutual communication with the server 200, the ITS device 300, nearby vehicles 300, and the like. The transmitting/receiving unit 112 may include a module that processes, for example, cellular communication, WAVE, DSRC communication, and the like. In the present disclosure, the transmitting/receiving unit 112 may transmit data generated or stored while driving to the server 200 and receive data and software modules transmitted from the server 200. The transmitting/receiving unit 112 may support communication with an electronic device carried by an occupant inside the vehicle 100. In the present disclosure, the vehicle 100 may transmit and receive data utilized in a method according to the present disclosure to and from the outside through the transmitting/receiving unit 112.

For example, the transmitting/receiving unit 112 may receive traffic signal information from a traffic signal controller and provide the traffic signal information to the processor 130. In addition, the transmitting/receiving unit 112 may receive a control signal from the traffic signal controller and provide the control signal to the processor 130.

In addition, the vehicle 100 may include the energy generating unit 110 and the actuating unit 116.

The energy generating unit 110 may generate and supply power and electric power used in a driving power system and a non-driving power system, such as the actuating unit 116. The non-driving power system may be, for example, the one or more sensors 102, the operating unit 106, the display 108, the load device 114, and the transmitting/receiving unit 112, but is not limited thereto, and may include various components that implement sensing, interface, communication, and convenience functions, excluding components directly involved in driving operations. If the vehicle 100 is driven based on electrical energy, the energy generating unit 110 may be configured as an electric battery charged from the outside, or configured as a combination of an electric battery and a fuel cell that charges the electric battery. In the case of the combination of the electric battery and the fuel cell, the energy generating unit 110 may include a tank that stores materials used to produce electric power for the fuel cell, such as liquefied hydrogen. If the vehicle 100 is driven based on fossil energy, the energy generating unit 110 may be configured as an internal combustion engine. In addition, if the vehicle 100 is a hybrid type, the energy generating unit 110 may be provided as a combination of the internal combustion engine and the electric battery.

The actuating unit 116 may be provided with at least one module that implements driving operations and perform at least one driving operation among longitudinal control such as acceleration and deceleration and lateral control such as steering, according to a user request from the operating unit 106. In order to perform driving operations according to a command of the processor 130 by manual operation of the user or autonomous driving, the actuating unit 116 may be provided with the wheel driving unit 118 and mechanical components and electronic modules for implementing the driving operations in the wheel driving unit 118. If the vehicle 100 is operated based on electrical energy, the actuating unit 116 may include an assembly for transmitting the requested driving operation to the wheel driving unit 118. If the vehicle 100 is operated based on fossil energy, the actuating unit 116 may be provided with a transmission and a gear module that transmit the power of the internal combustion engine.

The wheel driving unit 118 may include a plurality of wheels, a driving force generation module (e.g., engine, motor, etc.) for generating a driving force and applying the driving force to the wheels or transmitting the driving force, a braking module for slowing down the driving of the wheels, and a steering module for carrying out lateral control of the wheels. If the vehicle 100 is driven based on electrical energy, the driving force generating module may be configured as a motor assembly that generates a driving force based on electric power output from the electric battery. The braking module of the electric-based vehicle 100 may further have a regenerative braking function.

A navigation unit (also referred to as a navigation system) 122 may provide navigation information. The navigation information may include at least one of map information, set destination information, route information according to a set destination, information on various objects on the route, lane information, and current vehicle position information.

The navigation unit 122 may receive information from an external device through the transmitting/receiving unit 112 and update previously stored information. The navigation unit 122 may be classified as a sub-component of the operating unit 106.

The vibrator 140 may be provided on a backrest and a seat bottom of a seat and may independently output a vibration signal. The vibrator 140 may be disposed to be embedded in empty spaces of the backrest and the seat bottom of the seat. Each vibrator 140 operates independently under the control of the processor 130 and may output a predetermined vibration signal.

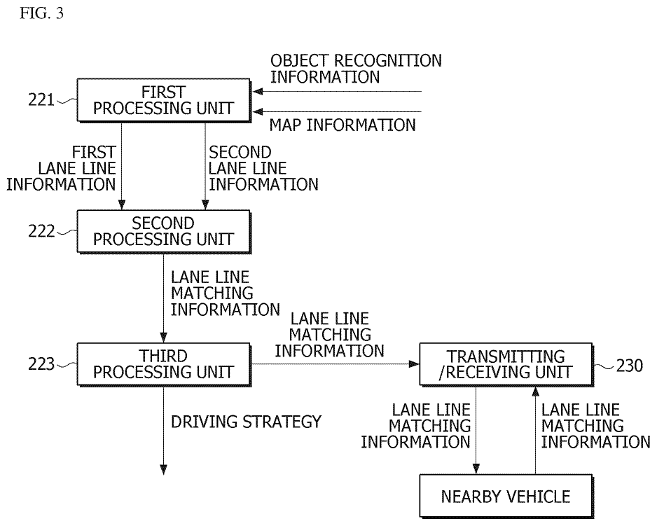

FIG. 3 is a diagram for describing the operation of a vehicle control device. Referring to FIG. 3, a vehicle control device may include a memory 210, a processor 220, and a transmitting/receiving unit 230. The memory 210 and the processor 220 of the vehicle control device may have the same configuration as the memory, the processor, and the transmitting/receiving unit in FIG. 2.

The memory 210 may store applications and various types of data for controlling the vehicle control device, and load applications or read and record data by a request of the processor 220.

The processor 220 may perform overall control of the vehicle control device. The processor 220 may be configured to execute applications and instructions stored in the memory 210.

The processor 220 may include a first processing unit (also referred to as a first processor) 221, a second processing unit (also referred to as a second processor) 222, and a third processing unit (also referred to as a third processor) 223.

The first processing unit 221 may determine first traffic lane marking information (also referred to as first lane line information) through object recognition information detected by the sensor unit, and determine second traffic lane marking information through map information of the navigation unit. Traffic lane markings may be also variously referred to as road markings, road surface markings, traffic lines, lane lines, traffic lane lines, pavement markings, pavement lines, etc. The traffic lane marking information may also be referred to as road marking information, road surface marking information, traffic line information, traffic lane line information, pavement marking information, pavement line information, etc. The traffic lane marking information may include information about the locations, directions, orientations, colors, shapes, types, grades (e.g., slopes), angles, etc. of one or more traffic lane markings.

The first processing unit 221 may determine the first traffic lane marking information using at least one of image information of the camera, point cloud data of the lidar, and radar data.

For example, the first processing unit 221 may determine a color and shape (e.g., dotted line, solid line) of a road traffic lane marking using the image information of the camera received from the first sensor unit.

For example, the first processing unit 221 may estimate the traffic lane marking by recognizing a height difference, surface shape, and the like, of a road using the point cloud data of the lidar received from the first sensor unit.

For example, the first processing unit 221 may determine distance information for an object or road structure using radar data received from the first sensor unit.

The second processing unit 222 may analyze map information received from the navigation unit to determine the second traffic lane marking information. The map information may be high-definition map (HD Map) information. A high-definition map may refer to a map or map data having a resolution (e.g., data resolution, image resolution, etc.) above a certain threshold value. The second processing unit 222 may determine the second traffic lane marking information by analyzing location, curvature, and traffic lane marking type (e.g., bus only, left turn only, or the like) information about the road included in the map information.

The first processing unit 221 may analyze object recognition information received from the sensor unit, recognize traffic lane markings according to a preset cycle, and output the first traffic lane marking information.

The second processing unit 222 may analyze the map information of the navigation unit, recognize the traffic lane marking based on information on a current location of the host vehicle, and output the second traffic lane marking information.

The first traffic lane marking information and the second traffic lane marking information may include point coordinates and traffic lane marking shape information.

The second processing unit 222 may analyze whether the first traffic lane marking information and the second traffic lane marking information match, determine an unmatched (e.g., unmatched) traffic lane marking that does not match from a traffic lane marking matching result, and calculate (e.g., determine) traffic lane marking matching information (also referred to as combined traffic lane marking information or matched traffic lane marking information) about the host vehicle.

For example, the second processing unit 222 may determine an unmatched (e.g., unmatched) traffic lane marking by comparing at least one of the coordinates, traffic lane marking slopes, and angles of the first traffic lane marking information and the second traffic lane marking information. The unmatched traffic lane marking may be a traffic lane marking detected in only one of the first traffic lane marking information and the second traffic lane marking information as a result of comparing the first traffic lane marking information and the second traffic lane marking information. Alternatively, the unmatched traffic lane marking may be a lane line that is difficult to define (e.g., below a threshold tolerance or confidence level) as the same traffic lane marking because, as the result of comparing between the first traffic lane marking information and the second traffic lane marking information, the location, shape, or the like, are different enough to affect the driving of the vehicle.

The second processing unit 222 may compare the first traffic lane marking information and the second traffic lane marking information recognized within a certain range based on the current location of the host vehicle to determine whether the first traffic lane marking information and the second traffic lane marking information match. The second processing unit 222 may convert the first traffic lane marking information and the second traffic lane marking information into the same coordinate system (e.g., WGS84) and compare them.

The second processing unit 222 may determine the unmatched (e.g., unmatched) traffic lane marking by comparing distances of the first traffic lane marking information and the second traffic lane marking information converted to the same coordinate system. The second processing unit 222 may calculate (e.g., determine) a distance value between a point coordinate of the first traffic lane marking information and a point coordinate of the second traffic lane marking information located on the same horizontal axis. The second processing unit 222 may determine a traffic lane marking whose distance value exceeds a reference distance value as the unmatched traffic lane marking. Alternatively, if a traffic lane marking whose distance value exceeds the reference distance value is maintained for a preset length or longer, the second processing unit 222 may determine the corresponding traffic lane marking as the unmatched traffic lane marking.

In addition, the second processing unit 222 may determine the unmatched traffic lane marking by comparing the shapes of traffic lane markings. The second processing unit 222 may compare traffic lane marking types included in the traffic lane marking information by coordinates and determine a traffic lane marking that does not match from a comparison result as the unmatched traffic lane marking. For example, if a traffic lane marking is classified as a solid line in the first traffic lane marking information, but as a dotted line in the second traffic lane marking information, the second processing unit 222 may determine the corresponding traffic lane marking as the unmatched traffic lane marking.

In addition, the second processing unit 222 may calculate (e.g., determine) an angle and slope of a traffic lane marking using an amount of change between point coordinates of the traffic lane marking. If the angle and slope of the traffic lane marking calculated (e.g., determined) from the first traffic lane marking information and the angle and slope of the traffic lane marking calculated (e.g., determined) from the second traffic lane marking information exceed a reference value, the second processing unit 222 may determine the corresponding traffic lane marking as the unmatched traffic lane marking.

For example, if the map information shows three traffic lane markings on a highway entrance ramp, but the number is reduced to two due to a road construction event, a matching result between the first traffic lane marking information and the second traffic lane marking information may indicate a mismatch.

The third processing unit 223 may establish a driving strategy to reach a destination by reflecting the traffic lane marking matching information about (e.g., collected by, determined by, generated by, etc.) the host vehicle.

For example, the third processing unit 223 may determine whether driving is possible even if an unmatched (e.g., unmatched) traffic lane marking is present or whether arrival at a preset destination is possible. The third processing unit 223 may determine that the unmatched traffic lane marking does not affect driving or arrival at the destination if the unmatched traffic lane marking is a traffic lane marking that does not affect a driving route of the host vehicle, that is, if the unmatched traffic lane marking is not a traffic lane marking on either side of the driving route of the host vehicle or a traffic lane marking located on a lane change route.

Alternatively, the third processing unit 223 may determine that the unmatched traffic lane marking does not affect arrival at the destination if a remaining distance to the destination is less than or equal to a predetermined distance.

Alternatively, if the unmatched traffic lane marking is caused by a mismatch in traffic lane marking types, the third processing unit 223 may determine that the unmatched traffic lane marking does not affect driving or arrival at the destination if a lane change crossing the corresponding traffic lane marking is not planned on a current driving route.

If it is determined that the unmatched traffic lane marking does not affect driving or arrival at the destination, the third processing unit 223 may establish a driving strategy to maintain the current driving route.

If it is determined that it is not possible to reach the destination according to a current driving strategy due to the unmatched traffic lane marking, the third processing unit 223 may establish an avoidance driving strategy (e.g., evasive maneuver) to avoid driving on the unmatched traffic lane marking.

For example, if the unmatched traffic lane marking is a traffic lane marking on either side of the driving route of the host vehicle, the third processing unit 223 may determine that the unmatched traffic lane marking affects driving or arrival at the destination.

Alternatively, the third processing unit 223 may determine that the unmatched traffic lane marking affects arrival at the destination if the remaining distance to the destination exceeds the predetermined distance.

Alternatively, if the unmatched traffic lane marking is caused by a mismatch in traffic lane marking types, the third processing unit 223 may determine that the unmatched traffic lane marking affects driving or arrival at the destination if the lane change crossing the corresponding traffic lane marking is planned on a current driving route.

If it is determined that the unmatched traffic lane marking affects driving or arrival at the destination, the third processing unit 223 may modify the current driving route and establish a driving strategy to avoid the unmatched traffic lane marking. The third processing unit 223 may establish the driving strategy by reflecting real-time traffic situations, road conditions, and the current location of the vehicle.

For example, the third processing unit 223 may establish a driving strategy to include an avoidance route to drive or reach the destination without changing lanes crossing the unmatched traffic lane marking.

Alternatively, the third processing unit 223 may establish a driving strategy to change the driving lane of the host vehicle if the unmatched traffic lane marking is a traffic lane marking on either side of the driving route of the host vehicle.

In this case, the third processing unit 223 may calculate (e.g., determine) a plurality of avoidance routes. The third processing unit 223 may calculate (e.g., determine) and output a plurality of avoidance routes through the operation unit, display, and the like, in the vehicle. The third processing unit 223 may establish the driving strategy through the selected avoidance route if there is a selection input of a driver.

Alternatively, when (e.g., after, while, etc.) the plurality of avoidance routes are calculated (e.g., determined), the third processing unit 223 may establish the driving strategy using an avoidance route that may reach the destination in the shortest time.

Alternatively, when (e.g., after, while, etc.) the plurality of avoidance routes are calculated (e.g., determined), the third processing unit 223 may establish the driving strategy by selecting an avoidance route that has the least impact on the unmatched traffic lane marking. For example, the third processing unit 223 may establish a driving strategy by selecting an avoidance route that is furthest from the unmatched traffic lane marking.

The third processing unit 223 may perform an autonomous driving release operation (e.g., deactivate autonomous driving) if it is determined that it is not possible to reach the destination according to the avoidance driving strategy due to the unmatched traffic lane marking. If it is determined that it is not possible to reach the destination through the avoidance route for the unmatched traffic lane marking, the third processing unit 223 may release autonomous driving to transfer a control right to the driver. The third processing unit 223 may output a driver takeover request to the driver through the operation unit, display, and the like, in the vehicle, and control the vehicle to stop the vehicle at a nearby available stop space to wait for a driver's decision.

Alternatively, the third processing unit 223 may output a temporary stop request to the driver through the operation unit, display, and the like, in the vehicle. If it is not possible to establish the driving strategy through the avoidance route, the third processing unit 223 may search for a nearby available stop space and output the temporary stop request to the driver. If there is a temporary stop approval input from the driver, the third processing unit 223 may drive to a retrieved nearby available stop space and perform a temporary stop.

The third processing unit 223 may use object recognition information from the sensor unit to determine whether a nearby vehicle is traveling within a predetermined distance radius based on a current driving location of the host vehicle. The third processing unit 223 may perform data communication with the nearby vehicles through the transmitting/receiving unit 230 if there are the nearby vehicles, and may request traffic lane marking matching information from the nearby vehicle and transmit and receive the traffic lane marking matching information to and from the nearby vehicles.

When (e.g., after, while, etc.) receiving traffic lane marking matching information from the nearby vehicle, the third processing unit 223 may establish the driving strategy by comparing traffic lane marking matching information about another vehicle collected from the nearby vehicle with the traffic lane marking matching information about the host vehicle.

The third processing unit 223 may determine that an abnormality occurs in the host vehicle (e.g., the traffic lane marking matching information generated by the host vehicle is inaccurate) if the unmatched traffic lane marking is included in the traffic lane marking matching information about the host vehicle and is not included in the traffic lane marking matching information about another vehicle. In this case, the third processing unit 223 may determine that an abnormality occurs in the sensor unit of the host vehicle.

If it is determined that the abnormality occurs in the host vehicle, the third processing unit 223 may perform the autonomous driving release operation (e.g., deactivate autonomous driving). The third processing unit 223 may release autonomous driving to transfer the control right to the driver. The third processing unit 223 may output a driver takeover request to the driver through the operation unit, display, and the like, in the vehicle, and control the vehicle to stop the vehicle at a nearby available stop space to wait for a driver's decision.

The third processing unit 223 may transmit the traffic lane marking matching information about (e.g., collected by, determined by, generated by, etc.) the host vehicle and the traffic lane marking matching information about another vehicle to a server if an unmatched traffic lane marking is included in the traffic lane marking matching information about (e.g., associated with) the host vehicle and the traffic lane marking matching information about (e.g., associated with) another vehicle. The third processing unit 223 may compare the coordinates of the unmatched traffic lane marking included in the traffic lane marking matching information about the host vehicle with the coordinates of the unmatched traffic lane marking included in the traffic lane marking matching information about another vehicle, determine that there is an error in the map information or there is an abnormality in the road condition if the coordinates are the same, and transmit the corresponding information to the server. In this case, the third processing unit 223 may request the server to respond with map information in which unmatched traffic lane marking information is reflected or map information in which the unmatched traffic lane marking information is modified.

In this case, the third processing unit 223 may improve the reliability of a determination result by comparing the traffic lane marking matching information about (e.g., collected by, determined by, generated by, etc.) the host vehicle with the traffic lane marking matching information about a preset number or more of other vehicles.

For example, the third processing unit 223 may determine whether driving is possible even if an unmatched traffic lane marking exists or whether arrival at a preset destination is possible. The third processing unit 223 may determine that the unmatched traffic lane marking does not affect driving or arrival at the destination if the unmatched traffic lane marking is a traffic lane marking that does not affect a driving route of the host vehicle, that is, if the unmatched traffic lane marking is not a traffic lane marking on either side of the driving route of the host vehicle or a traffic lane marking located on a lane change route.

Alternatively, the third processing unit 223 may determine that the unmatched traffic lane marking does not affect arrival at the destination if a remaining distance to the destination is less than or equal to a predetermined distance.

Alternatively, if the unmatched traffic lane marking is caused by a mismatch in traffic lane marking types, the third processing unit 223 may determine that the unmatched traffic lane marking does not affect driving or arrival at the destination if a lane change crossing the corresponding traffic lane marking is not planned on a current driving route.

If it is determined that the unmatched traffic lane marking does not affect driving or arrival at the destination, third processing unit 223 may establish a driving strategy to maintain the current driving route.

If it is determined that it is not possible to reach the destination according to a current driving strategy due to the unmatched traffic lane marking, the third processing unit 223 may establish an avoidance driving strategy to avoid driving on the unmatched traffic lane marking.

For example, if the unmatched traffic lane marking is a traffic lane marking on either side of the driving route of the host vehicle, the third processing unit 223 may determine that the unmatched traffic lane marking affects driving or arrival at the destination.

Alternatively, the third processing unit 223 may determine that the unmatched traffic lane marking affects arrival at the destination if the remaining distance to the destination exceeds the predetermined distance.

Alternatively, if the unmatched traffic lane marking is caused by a mismatch in traffic lane marking types, the third processing unit 223 may determine that the unmatched traffic lane marking affects driving or arrival at the destination if the lane change crossing the corresponding traffic lane marking is planned on a current driving route.

If it is determined that the unmatched traffic lane marking affects driving or arrival at the destination, the third processing unit 223 may modify the current driving route and establish a driving strategy to avoid the unmatched traffic lane marking. The third processing unit 223 may establish the driving strategy by reflecting real-time traffic situations, road conditions, and the current location of the vehicle.

For example, the third processing unit 223 may establish a driving strategy to include an avoidance route to drive or reach the destination without changing lanes crossing the unmatched traffic lane marking.

Alternatively, the third processing unit 223 may establish a driving strategy to change the driving lane of the host vehicle if the unmatched traffic lane marking is a traffic lane marking on either side of the driving route of the host vehicle.

In this case, the third processing unit 223 may calculate (e.g., determine) a plurality of avoidance routes. The third processing unit 223 may calculate (e.g., determine) and output a plurality of avoidance routes through the operation unit, display, and the like, in the vehicle. The third processing unit 223 may establish the driving strategy through the selected avoidance route if there is a selection input of a driver.

Alternatively, if the plurality of avoidance routes are calculated (e.g., determined), the third processing unit 223 may establish the driving strategy using an avoidance route that may reach the destination in the shortest time.

Alternatively, if the plurality of avoidance routes are calculated (e.g., determined), the third processing unit 223 may establish the driving strategy by selecting an avoidance route that has the least impact on the unmatched traffic lane marking. For example, the third processing unit 223 may establish a driving strategy by selecting an avoidance route that is furthest from the unmatched traffic lane marking.

The third processing unit 223 may perform an autonomous driving release operation if it is determined that it is not possible to reach the destination according to the avoidance driving strategy due to the unmatched traffic lane marking. If it is determined that it is not possible to reach the destination through the avoidance route for the unmatched traffic lane marking, the third processing unit 223 may release autonomous driving to transfer a control right to the driver. The third processing unit 223 may output a driver takeover request to the driver through the operation unit, display, and the like, in the vehicle, and control the vehicle to stop the vehicle at a nearby available stop space to wait for a driver's decision.

Alternatively, the third processing unit 223 may output a temporary stop request to the driver through the operation unit, display, and the like, in the vehicle. If it is not possible to establish the driving strategy through the avoidance route, the third processing unit 223 may search for a nearby available stop space and output the temporary stop request to the driver. If there is a temporary stop approval input from the driver, the third processing unit 223 may drive to a retrieved nearby available stop space and perform a temporary stop.

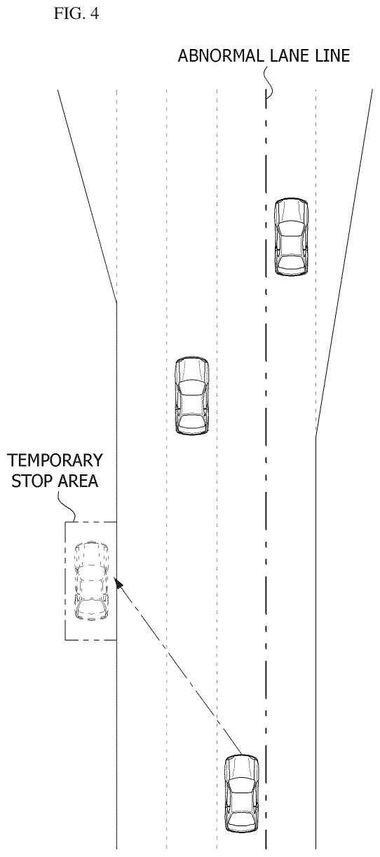

FIG. 4 is a conceptual diagram of the operation of a vehicle control device. Referring to FIG. 4, a host vehicle may be in a situation where the vehicle has to change lanes to the right along a current driving route, and map information and object recognition information are different, so that an unmatched traffic lane marking is detected on the right side of the host vehicle.

The vehicle control device may receive traffic lane marking matching information from a nearby vehicle, compare the traffic lane marking matching information with traffic lane marking matching information about (e.g., collected by, determined by, generated by, etc.) the host vehicle, and determine that an abnormality occurs in the host vehicle if the unmatched traffic lane marking is included in the traffic lane marking matching information about the host vehicle and is not included in the traffic lane marking matching information about another vehicle.

The vehicle control device may output a driver takeover request to the driver through the operation unit, display, and the like, in the vehicle, and control the vehicle to stop the vehicle at a nearby available stop space to wait for a driver's decision.

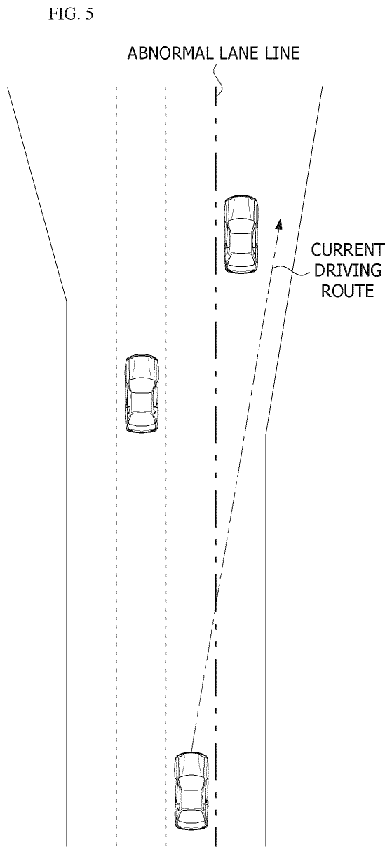

FIG. 5 is a conceptual diagram of the operation of a vehicle control device. Referring to FIG. 5, map information and object recognition information are different, and an unmatched traffic lane marking is detected on the left side of the host vehicle.

The vehicle control device may receive traffic lane marking matching information from a nearby vehicle, compare the traffic lane marking matching information with traffic lane marking matching information about the host vehicle, and determine whether it is possible to reach a destination through a current driving route if the unmatched traffic lane marking is included in both the traffic lane marking matching information about (e.g., collected by, determined by, generated by, etc.) the host vehicle and the traffic lane marking matching information about (e.g., collected by, determined by, generated by, etc.) another vehicle.

The vehicle control device may determine that the unmatched traffic lane marking is not related to a driving traffic lane marking of the host vehicle and that it is possible to reach the destination without changing lanes, and establish a driving strategy to maintain the current driving route.

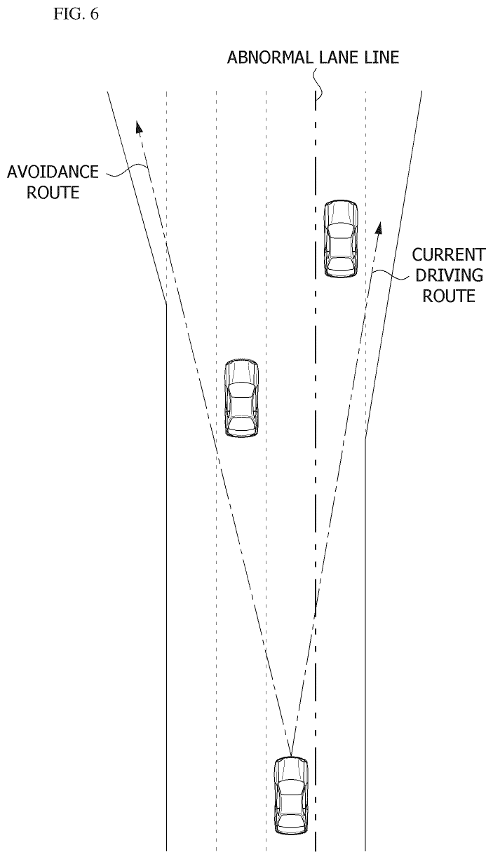

FIG. 6 is a conceptual diagram of the operation of a vehicle control device. Referring to FIG. 6, map information and object recognition information are different, and an unmatched traffic lane marking is detected on the left side of the host vehicle.

The vehicle control device may receive traffic lane marking matching information from a nearby vehicle, compare the traffic lane marking matching information with traffic lane marking matching information about the host vehicle, and determine whether it is possible to reach a destination through a current driving route if the unmatched traffic lane marking is included in both the traffic lane marking matching information about the host vehicle and the traffic lane marking matching information about another vehicle.

The host vehicle may be in a situation where the vehicle has to change lanes to the right along the current driving route, and an unmatched traffic lane marking is located on a lane change route. Accordingly, the vehicle control device may determine that it is not possible to reach a destination through a current driving route and calculate (e.g., determine) an avoidance route to establish a driving strategy.

The vehicle control device may output the avoidance route through the operation unit, display, and the like, in the vehicle, and control the operation of the vehicle according to a driving strategy using the avoidance route if there is an approval input from a driver.

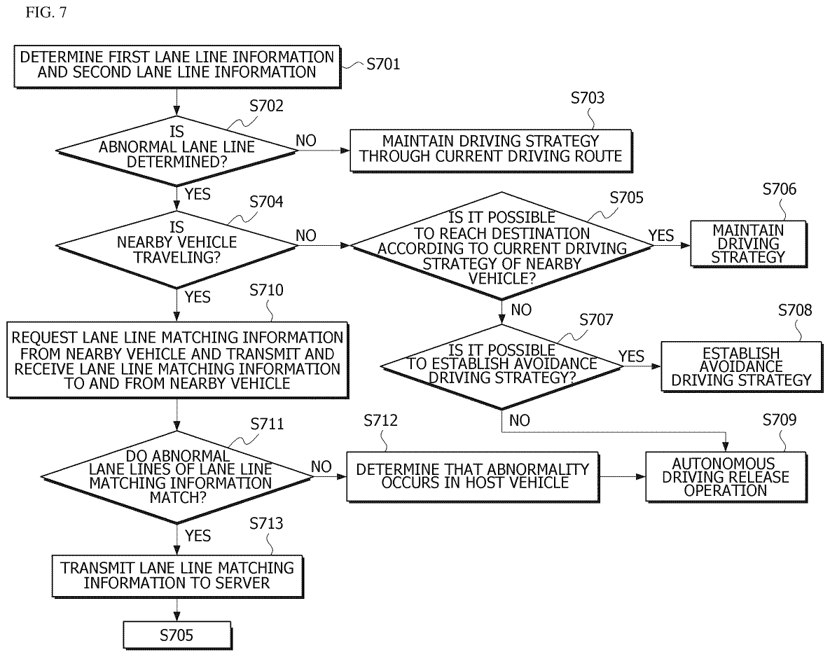

FIG. 7 is a flowchart of a method of controlling a vehicle. Referring to FIG. 7, the processor may determine first traffic lane marking information through object recognition information detected by the sensor unit, and determine second traffic lane marking information through map information of the navigation unit (S701).

The processor may analyze whether the first traffic lane marking information and the second traffic lane marking information match and determine (e.g., detect, identify, etc.) an unmatched traffic lane marking that does not match from a traffic lane marking matching result. The processor may calculate (e.g., determine) traffic lane marking matching information about the host vehicle including information about the unmatched traffic lane marking (S702).

The processor may maintain a driving strategy through a current driving route if no unmatched traffic lane marking is determined (S703).

When (e.g., after, while, etc.) the unmatched traffic lane marking is determined, the processor uses the object recognition information from the sensor unit to determine whether a nearby vehicle is traveling within a predetermined distance radius based on a current driving location of the host vehicle (S704).

If there is no nearby vehicle or traffic lane marking matching information about another vehicle is not received, the processor may determine a possibility of reaching a destination according to the current driving strategy by the unmatched traffic lane marking included in the traffic lane marking matching information about the host vehicle (S705).

The processor may maintain the driving strategy through the current driving route if it is possible to reach the destination according to the current driving strategy (S706).

If it is not possible to reach the destination according to the current driving strategy, the processor may establish an avoidance driving strategy to avoid driving on the unmatched (S707 and S708).

If it is not possible to establish the avoidance driving strategy or it is determined that it is not possible to reach the destination according to the avoidance driving strategy, the processor may perform an autonomous driving release operation (S709).

If there is a nearby vehicle, the processor may perform data communication with the nearby vehicle through the transmitting/receiving unit, and request traffic lane marking matching information from the nearby vehicle and transmit and receive the traffic lane marking matching information to and from the nearby vehicle (S710).

The processor compares the traffic lane marking matching information about the host vehicle with the traffic lane marking matching information about another vehicle collected from the nearby vehicle (S711).

If it is determined that the unmatched traffic lane marking is included in the traffic lane marking matching information about the host vehicle and is not included in the traffic lane marking matching information about another vehicle, the processor may determine that an abnormality occurs in the host vehicle (S712).

If it is determined that the abnormality occurs in the host vehicle, the processor may perform the autonomous driving release operation (S709).

Alternatively, the processor may transmit the traffic lane marking matching information about the host vehicle and the traffic lane marking matching information about another vehicle to the server if the unmatched traffic lane marking is included in the traffic lane marking matching information about the host vehicle and the traffic lane marking matching information about another vehicle (S713).

The processor may determine a possibility of reaching the destination according to the current driving strategy by the unmatched traffic lane marking included in the traffic lane marking matching information about the host vehicle (S705).

The processor may maintain the driving strategy through the current driving route if it is possible to reach the destination according to the current driving strategy (S706).

If it is not possible to reach the destination according to the current driving strategy, the processor may establish an avoidance driving strategy to avoid driving on the unmatched traffic lane marking (S707 and S708).

If it is determined that it is not possible to establish the avoidance driving strategy or that it is not possible to reach the destination according to the avoidance driving strategy, the processor may perform an autonomous driving release operation (S709).

There is provided a vehicle control device including a first processing unit configured to determine first lane line information through object recognition information detected by a sensor unit and determine second lane line information through map information of a navigation unit, a second processing unit configured to analyze whether the first lane line information and the second lane line information match to determine an unmatched lane line that does not match from a lane line matching result, and calculate lane line matching information about a host vehicle, and a third processing unit configured to establish a driving strategy of a vehicle by reflecting the lane line matching information about the host vehicle.

The second processing unit may determine the unmatched lane line by comparing at least one of coordinates, lane line slopes, and angles of the first lane line information and the second lane line information.

The third processing unit may establish an avoidance driving strategy to avoid driving on the unmatched lane line when it is determined that it is not possible to reach a destination according to the current driving strategy due to the unmatched lane line.

The third processing unit may perform an autonomous driving release operation when it is determined that it is not possible to reach the destination according to the avoidance driving strategy due to the unmatched lane line.

The third processing unit may establish the driving strategy by comparing the lane line matching information about the host vehicle with lane line matching information about another vehicle collected from a nearby vehicle.

The third processing unit may determine that an abnormality occurs in the host vehicle when the unmatched lane line is included in the lane line matching information about the host vehicle and is not included in the lane line matching information about another vehicle.

The third processing unit may perform an autonomous driving release operation when it is determined that the abnormality occurs in the host vehicle.

The third processing unit may transmit the lane line matching information about the host vehicle and the lane line matching information about another vehicle to a server when the unmatched lane line is included in the lane line matching information about the host vehicle and the lane line matching information about another vehicle.

The third processing unit may establish an avoidance driving strategy to avoid driving on the unmatched lane line when it is determined that it is not possible to reach the destination according to the current driving strategy due to the unmatched lane line.

The third processing unit may perform an autonomous driving release operation when it is determined that it is not possible to reach the destination according to the avoidance driving strategy due to the unmatched lane line.

There is provided a method of controlling a vehicle, including determining first lane line information through object recognition information detected by a sensor unit and determining second lane line information through map information of a navigation unit, analyzing whether the first lane line information and the second lane line information match to determine an unmatched lane line that does not match from a lane line matching result, calculating lane line matching information about a host vehicle including information on the unmatched lane line, and establishing a driving strategy for reaching a destination by reflecting the lane line matching information about the host vehicle.

The determining of the unmatched lane line may include comparing at least one of coordinates, lane line slopes, and angles of the first lane line information and the second lane line information to determine the unmatched lane line.

The establishing of the driving strategy may include establishing an avoidance driving strategy to avoid driving on the unmatched lane line when it is determined that it is not possible to reach the destination according to the current driving strategy due to the unmatched lane line.

The establishing of the driving strategy may include performing an autonomous driving release operation when it is determined that it is not possible to reach the destination according to the avoidance driving strategy due to the unmatched lane line.

The establishing of the driving strategy may include comparing the lane line matching information about the host vehicle with lane line matching information about another vehicle collected from a nearby vehicle to establish the driving strategy.

The establishing of the driving strategy may include determining that an abnormality occurs in the host vehicle when the unmatched lane line is included in the lane line matching information about the host vehicle and is not included in the lane line matching information about another vehicle.

The establishing of the driving strategy may include performing an autonomous driving release operation when it is determined that the abnormality occurs in the host vehicle.

The establishing of the driving strategy may include transmitting the lane line matching information about the host vehicle and the lane line matching information about another vehicle to a server when the unmatched lane line is included in the lane line matching information about the host vehicle and the lane line matching information about another vehicle.

The establishing of the driving strategy may include establishing an avoidance driving strategy to avoid driving on the unmatched lane line when it is determined that it is not possible to reach the destination according to the current driving strategy due to the unmatched lane line.

The establishing of the driving strategy may include performing an autonomous driving release operation when it is determined that it is not possible to reach the destination according to the avoidance driving strategy due to the unmatched lane line.

The term “unit” used in the present disclosure may refer to software components, hardware components, or a combination of both, such as a field-programmable gate array (FPGA) or an application specific integrated circuit (ASIC), and “unit” performs certain functions. However, the “unit” is not limited to software or hardware. The “unit” may be configured to reside in an addressable storage medium, or may be configured to reproduce one or more processors. Therefore, for example, “unit” includes components such as software components, object-oriented software components, class components, and task components, and includes processes, functions, attributes, procedures, sub-routines, segments of program code, drivers, firmware, micro code, circuits, data, a database, data structures, tables, arrays, and variables. Functions provided in the components and the “unit” may be combined into smaller numbers of components and “units,” or may be further divided into additional components and “units.” Furthermore, the components and “units” may be implemented to reproduce one or more CPUs in a device or a security multimedia card.

With a vehicle control device and method according to the present disclosure, it is possible to stably maintain driving even in a situation where traffic lane marking information recognized by an autonomous vehicle and traffic lane marking information of an HD map do not match.

In addition, it is possible to diagnose the cause of traffic lane marking information mismatch and generate an alternative route.

In addition, it is possible to maximize driving stability and minimize the number of times autonomous driving is released.

In this way, it is possible to alleviate traffic congestion and improve the marketability of autonomous driving.

Although one or more example embodiments of the present disclosure have been described above, it is understood that those skilled in the art can make various changes and modifications to the present disclosure without departing from the spirit and scope of the present disclosure set forth in the claims below.

What is claimed is:

1. A vehicle control device comprising:
a plurality of processors comprising a first processor, a second processor, and a third processor; and
a memory storing at least one instruction,
wherein the at least one instruction is configured, when executed by the first processor communicating with the memory, to cause the vehicle control device to:
determine, based on object recognition information received from a sensor of a vehicle, first traffic lane marking information; and
determine, based on map information received from a navigation system of the vehicle, second traffic lane marking information,
wherein the at least one instruction is configured, when executed by the second processor communicating with the memory, to further cause the vehicle control device to:
generate combined traffic lane marking information of the vehicle by comparing the first traffic lane marking information with the second traffic lane marking information, wherein the combined traffic lane marking information indicates at least one unmatched traffic lane marking for which the first traffic lane marking information and the second traffic lane marking information do not match, and
wherein the at least one instruction is configured, when executed by the third processor communicating with the memory, to further cause the vehicle control device to:
control, based on the combined traffic lane marking information, a driving operation of the vehicle.

2. The vehicle control device of claim 1, wherein the at least one instruction is configured, when executed by the second processor communicating with the memory, to further cause the vehicle control device to:
determine the at least one unmatched traffic lane marking by comparing at least one of coordinates, traffic lane marking slopes, or angles of the first traffic lane marking information and the second traffic lane marking information.

3. The vehicle control device of claim 1, wherein the at least one instruction is configured, when executed by the third processor communicating with the memory, to cause the vehicle control device to control the driving operation of the vehicle by:
controlling, based on a determination that a destination of the vehicle is unreachable by driving on a traffic lane associated with the unmatched traffic lane marking, the vehicle to avoid driving on the traffic lane associated with the unmatched traffic lane marking.

4. The vehicle control device of claim 3, wherein the at least one instruction is configured, when executed by the third processor communicating with the memory, to cause the vehicle control device to control the driving operation of the vehicle by:
causing, based on a determination that the destination of the vehicle is unreachable by avoiding driving on the traffic lane associated with the unmatched traffic lane marking, deactivation of an autonomous driving operation of the vehicle or an autonomous driving level change of the autonomous driving operation of the vehicle.

5. The vehicle control device of claim 1, wherein the at least one instruction is configured, when executed by the third processor communicating with the memory, to cause the vehicle control device to control the driving operation of the vehicle by:
comparing the combined traffic lane marking information generated by the vehicle control device with second combined traffic lane marking information generated by a second vehicle.

6. The vehicle control device of claim 5, wherein the at least one instruction is configured, when executed by the third processor communicating with the memory, to cause the vehicle control device to control the driving operation of the vehicle by:
determining, based on the unmatched traffic lane marking not being identified in the second combined traffic lane marking information as being unmatched, the combined traffic lane marking information generated by the vehicle to be inaccurate.

7. The vehicle control device of claim 6, wherein the at least one instruction is configured, when executed by the third processor communicating with the memory, to cause the vehicle control device to control the driving operation of the vehicle by:
causing, based on the determination that the combined traffic lane marking information generated by the vehicle being inaccurate, deactivation of an autonomous driving operation of the vehicle or an autonomous driving level change of the autonomous driving operation of the vehicle.

8. The vehicle control device of claim 5, wherein the at least one instruction is configured, when executed by the third processor communicating with the memory, to cause the vehicle control device to control the driving operation of the vehicle by:
based on the unmatched traffic lane marking being identified in the second combined traffic lane marking information as being unmatched, transmitting, to a server, the combined traffic lane marking information generated by the vehicle and the second combined traffic lane marking information generated by the second vehicle.

9. The vehicle control device of claim 8, wherein the at least one instruction is configured, when executed by the third processor communicating with the memory, to cause the vehicle control device to control the driving operation of the vehicle by:
controlling, based on a determination that a destination of the vehicle is unreachable by driving on a traffic lane associated with the unmatched traffic lane marking, the vehicle to avoid driving on the traffic lane associated with the unmatched traffic lane marking.

10. The vehicle control device of claim 9, wherein the at least one instruction is configured, when executed by the third processor communicating with the memory, to cause the vehicle control device to control the driving operation of the vehicle by:
causing, based on a determination that the destination of the vehicle is unreachable by avoiding driving on the traffic lane associated with the unmatched traffic lane marking, deactivation of an autonomous driving operation of the vehicle or an autonomous driving level change of the autonomous driving operation of the vehicle.

11. A method performed by an apparatus of a vehicle, the method comprising:
determining, based on object recognition information received from a sensor of the vehicle, first traffic lane marking information;
determining, based on map information received from a navigation system of the vehicle, second traffic lane marking information;
generating combined traffic lane marking information of the vehicle by comparing the first traffic lane marking information with the second traffic lane marking information, wherein the combined traffic lane marking information indicates at least one unmatched traffic lane marking for which the first traffic lane marking information and the second traffic lane marking information do not match; and
controlling, based on the combined traffic lane marking information, a driving operation of the vehicle.

12. The method of claim 11, further comprising:
determining the at least one unmatched traffic lane marking by comparing at least one of coordinates, traffic lane marking slopes, or angles of the first traffic lane marking information and the second traffic lane marking information.

13. The method of claim 11, wherein the controlling of the driving operation of the vehicle comprises:
controlling, based on a determination that a destination of the vehicle is unreachable by driving on a traffic lane associated with the unmatched traffic lane marking, the vehicle to avoid driving on the traffic lane associated with the unmatched traffic lane marking.

14. The method of claim 13, wherein the controlling of the driving operation of the vehicle comprises:
causing, based on a determination that the destination of the vehicle is unreachable by avoiding driving on the traffic lane associated with the unmatched traffic lane marking, deactivation of an autonomous driving operation of the vehicle or an autonomous driving level change of the autonomous driving operation of the vehicle.

15. The method of claim 11, wherein the controlling of the driving operation of the vehicle comprises:
comparing the combined traffic lane marking information generated by the apparatus of the vehicle with second combined traffic lane marking information generated by a second vehicle.

16. The method of claim 15, wherein the controlling of the driving operation of the vehicle comprises:
determining, based on the unmatched traffic lane marking not being identified in the second combined traffic lane marking information as being unmatched, the combined traffic lane marking information generated by the vehicle to be inaccurate.

17. The method of claim 16, wherein the controlling of the driving operation of the vehicle comprises:
causing, based on the determination that the combined traffic lane marking information generated by the vehicle being inaccurate, deactivation of an autonomous driving operation of the vehicle or an autonomous driving level change of the autonomous driving operation of the vehicle.

18. The method of claim 15, wherein the controlling of the driving operation of the vehicle comprises:
based on the unmatched traffic lane marking being identified in the second combined traffic lane marking information as being unmatched, transmitting, to a server, the combined traffic lane marking information generated by the vehicle and the second combined traffic lane marking information generated by the second vehicle.

19. The method of claim 18, wherein the controlling of the driving operation of the vehicle comprises:
controlling, based on a determination that a destination of the vehicle is unreachable by driving on a traffic lane associated with the unmatched traffic lane marking, the vehicle to avoid driving on the traffic lane associated with the unmatched traffic lane marking.

20. The method of claim 19, wherein the controlling of the driving operation of the vehicle comprises:
causing, based on a determination that the destination of the vehicle is unreachable by avoiding driving on the traffic lane associated with the unmatched traffic lane marking, deactivation of an autonomous driving operation of the vehicle or an autonomous driving level change of the autonomous driving operation of the vehicle.
